(19) United States
(12) Patent Application Publication
(10) Pub. No.: US 2008/0210793 A1
(43) Pub. Date: Sep. 4, 2008

(54) Jaw Crusher

(75) Inventor: Paul Douglas, Derbyshire (GB)

Correspondence Address: KIRTON AND MCCONKIE, 60 EAST SOUTH TEMPLE,, SUITE 1800, SALT LAKE CITY, UT, 84111, US

(73) Assignee: Extec Screens and Crushers Limited, Derbyshire (GB)

(21) Appl. No.: 10/550,036

(22) PCT Filed: Mar. 18, 2004
(86) PCT No.: PCT/GB2004/001185

§ 371 Date: Feb. 7, 2007

(30) Foreign Application Priority Data
Mar. 21, 2003 (GB) 0306491.2

(51) Int. Cl. B02C 1/10; B02C 19/00

(52) U.S. Cl. 241/200

(57) ABSTRACT

A jaw crusher having two jaws which define an upwardly open crushing chamber for receiving crushable material and a discharge opening between the lower ends of the jaws for discharging crushed material, in which the jaws are relatively movable so as to vary the size of the crushing chamber and apply a working action and a relieving action on the crushable material each jaw has a durable facing surface which is engagable with the crushable material; and a set of interconnected jaw plates is provided for at least one of the jaws and is arranged so that at least some of the jaw plates form at least part of the facing surface of the jaw, said set of jaw plates being movably mounted on the jaw.

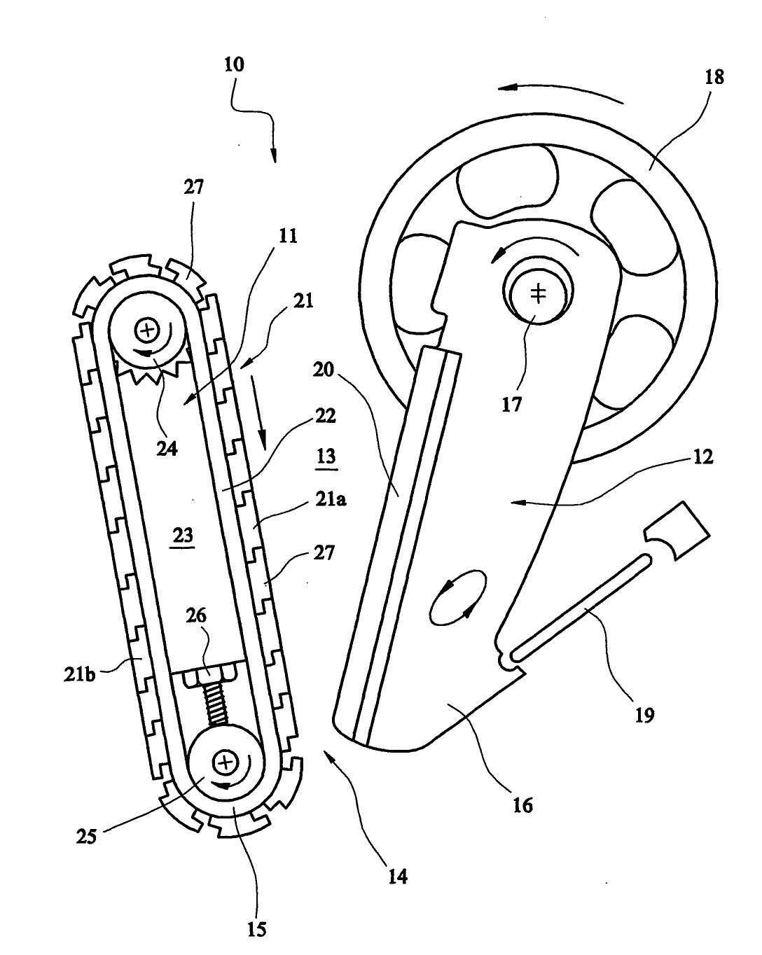

This invention relates to a jaw crusher having two jaws which define an upwardly open crushing chamber for receiving crushable material and a discharge opening between the lower ends of the jaws for discharging crushed material, the jaws being relatively movable so as to vary the size of the crushing chamber and apply a working action and a relieving action on the crushable material.

Jaw crushers usually comprise a first fixedly mounted jaw and a second movably mounted jaw which is driven by an oscillating drive mechanism to and fro, relative to the fixed jaw in order to apply the working and relieving actions on the material. As the material is crushed to smaller size, it migrates downwardly under gravity action towards, and eventually downwardly through the discharge opening.

It is normal to provide “wear plates” on the facing surfaces of the two jaws, and which necessarily are of robust and durable construction, and assembly to the jaws, in view of the arduous nature of the working environment i.e. crushing rocks. However, over a period of time, it is inevitable that the wear plates become subject to unacceptable wearing action and require to be replaced.

Obviously, the operation of the jaw crusher must be interrupted, so that wear plate replacement can take place, and which represents significant downtime of an expensive piece of capital equipment, which clearly is undesirable and has cost implications to the overall efficiency of the crushing operation. Also, since the wear plates extend continuously throughout the facing surfaces of the jaws, an entire wear plate must be replaced, even if unacceptable wear or damage has arisen on a small portion only of the surface of the wear plate.

Furthermore, substantial dust and other debris is inevitably generated during a crushing operation, and which can migrate into corners and crevices and become lodged there, and which can include access openings leading to fasteners which are used to secure the wear plates to the jaws (wear plates are usually bolted to corresponding jaw beams). This can further increase the downtime in having to release jammed fastener fittings.

The present invention therefore has been developed primarily with a view to facilitate the replacement of a worn working component on the facing surface of at least one of the jaws of a jaw crusher.

According to the invention there is provided a jaw crusher having two jaws which define an upwardly open crushing chamber for receiving crushable material and a discharge opening between the lower ends of the jaws for discharging crushed material, in which:

the jaws are relatively movable so as to vary the size of the crushing chamber and apply a working action and a relieving action on the crushable material;

each jaw has a durable facing surface which is engagable with the crushable material; and

a set of interconnected jaw plates is provided for at least one of the jaws and is arranged so that at least some of the jaw plates form at least part of the facing surface of the jaw, said set of jaw plates being movably mounted on the jaw.

The movement of the set of jaw plates may be continuous, semi-continuous, intermittent, or in case of need only.

Preferably, the movement of the set of jaw plates is continuous, and in a downward direction with respect to the facing surface of the jaw, and which assists is applying a downward pulling force on the material between the jaws. This also brings successive jaw plates into position on the facing surface, and which reduces the wearing action compared with the action to which a fixed wear plate is exposed.

As an alternative, the jaw plates on the facing surface may be moved when wear arises, so that a different array of jaw plates can be moved to form part of the facing surface.

Preferably, the set of interconnected jaw plates is movable throughout the facing surface of the jaw, and such movement may be downward movement. However, it is within the scope of the invention for the movement to be upward movement; or to be transverse movement in a direction from front to rear, or rear to front, with respect to the crushing chamber.

The set of jaw plates may form an endless array which is guided to move along an endless track. Such track may be mounted on front and rear faces of a beam of the jaw.

In the event of damage or excessive wear to any one or more individual jaw plate, it is preferred that each jaw plate is arranged to be easily mountable in, or removed from the set of interconnected jaw plates, so that replacement can be easily carried out.

With an endless track, it may be convenient for worn plates to be replaced as they move along the rear face of the jaw beam when, of course, they are inoperative.

It is particularly preferred that the set of interconnected jaw plates is mounted on a fixed jaw of a two jaw crusher, in which one jaw is fixed and the other jaw is movable to and fro under the action of an eccentric drive mechanism relative to the fixed jaw.

The movable jaw preferably also has a double toggle linkage coupled therewith.

A preferred embodiment of jaw crusher according to the invention will now be described in detail, by way of example only, with reference to the accompanying schematic drawing, which is a front view of the fixed and movable jaws of a two jaw crusher.

Referring to the drawing, a jaw crusher according to the invention is designated generally by reference 10, and has two jaws 11 and 12 which define an upwardly open crushing chamber 13 for receiving crushable material and a discharge opening 14 between the lower ends 15 and 16 of the jaws 11 and 12 for discharging crushed material.

The jaws 11 and 12 are relatively movable so as to vary the size of the crushing chamber 13 and apply a working action and a relieving action on the crushable material. Also, each jaw has a durable facing surface which is engageable with the crushable material. Conventionally, the jaws of a jaw-type rock crusher have wear plates mounted on respective jaw beams of the jaw crusher.

In the illustrated embodiment, which is preferred, the jaw 11 is a fixed jaw, and the jaw 12 is a movable jaw which is moved to and fro relative to the fixed jaw 11 under the action of a fly wheel-driven eccentric drive coupled with the upper end of the movable jaw 12, and shown schematically by reference 17 for the eccentric and reference 18 for the fly wheel. This forms an oscillating drive mechanism which applies limited to and fro movement to the upper end of the movable jaw 12, whereby to apply necessary powerful crushing action on the rock material or other crushable material received continuously or semi-continuously by the chamber 13. The movable jaw 12 also has a double toggle linkage shown schematically only and designated by reference 19, and which is adjustable to set any required width of the discharge opening 14.

The movable jaw 12 may have a conventional “swing jaw plate” 20 which forms the facing and working surface of the movable jaw 12. However, the fixed jaw 11 does not have a conventional wear plate forming its facing surface, but is provided with a particularly preferred embodiment of the invention which will now be described in detail.

In particular, the jaw 11 is provided with a set of interconnected jaw plates which is arranged so that at least some of the jaw plates form at least part of the facing surface of the jaw 11. In the illustrated embodiment, the entire facing surface of the jaw is actually formed by the set of interconnected jaw plates, and this is a preferred arrangement. Further, the set of jaw plates is movably mounted on the jaw 11 so that when at least part of the facing surface becomes worn, a different array of jaw plates can be moved to replace the previously worn or damaged part of the facing surface.

In a preferred mode of operation, the movement of the set of jaw plates is continuous, and in a downward direction with respect to the facing surface of the jaw, and which assists in applying a downward pulling force on the material between the jaws. This also brings successive jaw plates in to position on the facing surface, and which reduces the wearing action compared with the action to which a fixed wear plate is exposed.

The set of interconnected jaw plates is designated generally by reference 21 and, in the illustrated embodiment, is an endless array which is guided to move along an endless track 22 which is mounted on the front and rear faces of a beam 23 of the jaw 11. The set of jaw plates 21 therefore has a working run 21a, as the individual jaw impact plates move downwardly over the facing surface, and an upward return run 21b when the jaw plates are out of use. Upper and lower drive sprockets 24 and 25 respectively drive the endless set of jaw plates around the endless track 22. The movement may be continuous, semi-continuous, intermittent, or in case of need only. A tension adjustment mechanism 26 may be provided, engageable with the lower sprocket 25.

The set of interconnected jaw plates 21 is assembled from a number of individual jaw impact plates 27, and which can be easily mounted in position, or removed, so that replacement can easily be carried out in the event of damage or unacceptable wear to individual plates 27. Evidently, it may be convenient for worn or damaged impact plates 27 to be replaced as they are moving along the upwardly moving rear inoperative run 21b.

The illustrated embodiment provides for downward movement of the set of plates 27 along the facing surface of the jaw 11, and upward movement along the rear face of the jaw. Evidently, this movement could be reversed. Alternatively, the set of interconnected jaw plates may be mounted so as to be movable from front to rear, or from rear to front, with respect to the chamber 13 and perpendicularly of the general plane of the jaw 11.

It is preferred that the set of interconnected jaw plates 21 is provided on the fixed jaw 11. However, it is within the scope of the invention for such arrangement, suitably modified, to be mounted on the movable jaw 12 in addition, or as an alternative.

1. A jaw crusher having two jaws which define an upwardly open crushing chamber for receiving crushable material and a discharge opening between the lower ends of the jaws for discharging crushed material, in which:
the jaws are relatively movable so as to vary the size of the crushing chamber and apply a working action and a relieving action on the crushable material;
each jaw has a durable facing surface which is engagable with the crushable material; and
a set of interconnected jaw plates is provided for at least one of the jaws and is arranged so that at least some of the jaw plates form at least part of the facing surface of the jaw, said set of jaw plates being movably mounted on the jaw.

2. A jaw crusher according to claim 1, in which the set of interconnected jaw plates is movable throughout the facing surface of the jaw.

3. A jaw crusher according to claim 2, in which the movement throughout the facing surface of the jaw is downward movement.

4. A jaw crusher according to claim 2, in which the movement of the set of jaw plates is transverse movement in a direction from front to rear, or rear to front, with respect to the crushing chamber.

5. A jaw crusher according to claim 1, in which the set of jaw plates forms an endless array which is guided to move along an endless track.

6. A jaw crusher according to claim 5, in which the track is mounted on the front and rear faces of a beam of the jaw.

7. A jaw crusher according to claim 1, in which each jaw plate is arranged to be easily mountable in, or removable from the set of interconnected jaw plates, so that replacement can easily be carried out.

8. A jaw crusher according to claim 1, in which the set of interconnected jaw plates is mounted on a fixed jaw of a crusher, the other jaw being movable to and fro under the action of an eccentric drive mechanism relative to the fixed jaw.

9. A jaw crusher according to claim 8, in which the movable jaw is coupled with a double toggle linkage.

10. A jaw crusher according to claim 1, in which the set of jaw plates is continuously movable downwardly with respect to the facing surface of the jaw, to assist in pulling downwardly the material which is located between the jaws.
